(19) United States
(12) Patent Application Publication
(10) Pub. No.: US 2008/0222028 A1
(43) Pub. Date: Sep. 11, 2008

(54) Method and System for Providing Mortgage Data Quality Control Verification

(76) Inventor: Carlos F. Santiago, Newburgh, NY (US)

Correspondence Address: BRINKS HOFER GILSON & LIONE, P.O. BOX 10395, CHICAGO, IL, 60610, US

(21) Appl. No.: 12/020,422

(22) Filed: Jan. 25, 2008

Related U.S. Application Data
(60) Provisional application No. 60/886,844, filed on Jan. 26, 2007.

(51) Int. Cl. G06Q 40/00

(52) U.S. Cl. 705/38

(57) ABSTRACT

A computer implemented quality control system configured for verification of mortgage loan data is disclosed. The system includes a network interface device, a processor in communication with the network interface device via a communication bus, a memory in communication with the processor and the network interface device via the communication bus. The memory is configured to store computer readable instructions programmed to include, an interface module configured to receive mortgage loan data, wherein the mortgage loan data represents a plurality of existing individual mortgages from one or more mortgage sources, a parameter control module configured to store twenty or more predetermined quality control parameters, wherein the quality control parameters represent potential inconsistencies, inaccuracies, missing information, or combinations thereof in the mortgage loan data, a command module configured to store processing instructions utilized to comprehensively analyze the received the mortgage loan data, and a quality control module in communication with the interface module, the parameter control module and the command module, wherein the quality control module is configured to utilize the quality control parameters and the processing instructions to identify anomalies in the received mortgage loan data.

### CROSS-REFERENCE TO RELATED APPLICATIONS

This patent claims the priority benefit under 35 U.S.C. §119(e) of U.S. provisional patent application Ser. No. 60/886,844, filed on Jan. 26, 2007. The content of this application is hereby incorporated by reference for all purposes.

### BACKGROUND

Known systems and methods utilized for validating, remediating and converting mortgage loan data received from disparate sources into a clean, standardized format are time and labor intensive. The mortgage loan data provided by the various, disparate sources may contain anomalies, errors and/or corrupted data that may reduce the quality and usefulness of the information. For example, a mortgage data record may have one data field that indicates that a fixed rate mortgage has been selected by the borrower and other data fields may indicate an adjustable rate product. The ARM loan data fields are inconsistent with the first data field.

Known systems and methods provide an ad-hoc approach to identifying and addressing mortgage loan data errors, anomalies, etc. For example, in some systems, the mortgage loan data errors and anomalies are manually detected by the users after the information is received. Known automated systems and methods have provided non-comprehensive strategies for identifying and analyzing the errors and anomalies in the mortgage loan data. Known automated systems and methods attempt to react to and identify errors and anomalies within the mortgage loan data. Known automated systems and methods do not provide a proactive and consistent approach to screening, analyzing and verifying mortgage loan data.

### SUMMARY

In one embodiment, a computer implemented quality control system configured for verification of mortgage loan data is disclosed. The system includes a network interface device, a processor in communication with the network interface device via a communication bus, a memory in communication with the processor and the network interface device via the communication bus. The memory is configured to store computer readable instructions programmed to include, an interface module configured to receive mortgage loan data, wherein the mortgage loan data represents a plurality of existing individual mortgages from one or more mortgage sources, a parameter control module configured to store twenty or more predetermined quality control parameters, wherein the quality control parameters represent potential inconsistencies, inaccuracies, missing information, or combinations thereof in the mortgage loan data, a command module configured to store processing instructions utilized to comprehensively analyze the received the mortgage loan data, and a quality control module in communication with the interface module, the parameter control module and the command module, wherein the quality control module is configured to utilize the quality control parameters and the processing instructions to identify anomalies in the received mortgage loan data.

In another embodiment, a method for providing quality control verification of mortgage loan data is disclosed. The method includes receiving a plurality of mortgage loan data such that each of the plurality of mortgage loan data includes a plurality of data fields and each of the data fields relates to a subject property, analyzing the received plurality of mortgage loan data and identifying anomalies in the received plurality of mortgage loan data as a function of one or more quality control parameters, and correcting the anomalies identified within the analyzed mortgage loan data.

In another embodiment, a method for providing quality control verification of mortgage loan data is disclosed. The method includes receiving a plurality of mortgage loan data, wherein each of the plurality of mortgage loan data includes a plurality of data fields and each of the data fields relates to a subject property, analyzing the received plurality of mortgage loan data. Analyzing further includes identifying anomalies in the received data fields of the plurality of mortgage loan data as a function of one or more quality control parameters, identifying anomalies in the received data fields of the plurality of mortgage loan data as a function of a second group of received data fields of the plurality of mortgage loan data, and generating a report based on the identified anomalies.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 illustrates an block diagram embodiment of an exemplary quality control method configured in accordance with the disclosure provided herein; and

FIG. 2 illustrates a flowchart embodiment of the exemplary quality control method shown in FIG. 1.

### DETAILED DESCRIPTION

The present disclosure relates a method and system for providing mortgage loan-level quality control check. The disclosed quality control (QC) method and system may analyze the mortgage loan data relating to an approved loan for a subject property and determine if the provided information includes missing or suspect values based on one or more predetermined quality control parameters. The mortgage loan data relating to the approved loan includes then information provided on the completed loan application submitted by the borrower and/or the loan originator. Further, this information may be utilized by a loan servicing entity to monitor and/or control the existing or approved loan throughout its life or maturity period. The predetermined quality control parameters may be defined and/or implemented as a check list of quality control guidelines, rules or values. The quality control parameters may be utilized to manually or automatically detect errors or anomalies in the mortgage loan data. The disclosed QC system and method may further be utilized to correct or report the detected errors or anomalies to the user.

One embodiment of an exemplary QC system and method may ensure quality and consistency of mortgage level data before the data is supplied or provided to another party for further processing or utilization. The exemplary QC system and method may utilize a comprehensive and/or holistic process for analyzing and verifying mortgage level data.

For example, the exemplary QC system and method may utilize a comprehensive process that checks specific conditions and applies predefined business rules to the mortgage loan data to perform an exhaustive analysis of the data. In one embodiment, one-hundred and eighty (180) different checks based on various quality control parameters may be performed by the exemplary QC system and method. The number of checks or rules that may be executed to validate the mortgage loan data may be defined or changed based on the quality of the received mortgage loan data, historical analyses, time and/or processing constraints.

The checks may be organized into at least three (3) categories: (1) Valid Values; (2) Internal Consistency; and (3) Temporal Consistency. The valid values category checks or analyzes the information, values, etc. in the data fields of the mortgage loan data on a standalone basis to determine if the field contains information or values that are expected and logical. The internal consistency category simultaneously checks or analyzes two or more fields to determine whether the values in the fields in question are consistent with respect to each other. The temporal consistency category checks or analyzes data fields that have a time dimension to them (loan balance for example). These temporal fields have values that are compared to each other at two or more different points in time (usually, for example, “last month” and “this month”) to determine if the values comply with predefined business rules.

Alternatively or additionally, the exemplary QC system and method may utilize a holistic process to analyze or evaluate the mortgage loan data. For example, quality control analysis of the mortgage loan data may be performed at several points in the overall check or verification process and not just at the beginning or end of the process. Utilizing a continuous or frequent quality control analysis during multiple stages allows for identification of the source or root cause of an error identified within the mortgage loan data. Quality control analysis of the mortgage loan data may be viewed tactically as a proactive activity, not reactive.

As previously discussed, the findings of the quality control analysis of the mortgage loan data may be analyzed to assess root causes and sources of the anomalies. Anomalies may be fixed thereby allowing something which appears to be “wrong” to be corrected. However, these corrections may be implemented cautiously to ensure that the anomaly isn't made into an error or otherwise further corrupt the mortgage loan data.

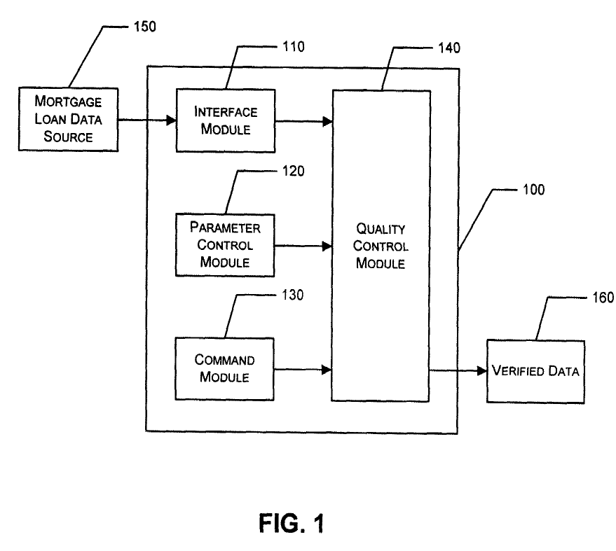

FIG. 1 is a diagram illustrating an embodiment of an exemplary quality control (QC) system 100 configured in accordance with the disclosure provided herein. The QC system or system 100 may include, for example, an interface module 110, a parameter control module 120, a command module 130 and a quality control module 140.

The QC system or system 100 may be embodied as computer readable instructions stored in a memory 170 and executable by a processor 180 in communication with the memory 170 via a communication bus 195. The system 100 may further include a wired or wireless network interface device 190 configured to receive or communicate information. The system 100 may be embodied in hardware or firmware. FIG. 1 illustrates one modular configuration that may be utilized by a data originator, mortgage reseller and/or aggregator, mortgage servicing entity, and a mortgage purchaser. The modules are implemented by the processor 180 or other device. The modular configuration may include more modules, fewer modules or modules identified by different names or conventions. Alternatively, the modular configuration may be implemented as programmable software or computer readable code or as fixed or programmable hardware.

The interface module 110 may provide a dynamic interface between the system 100 and a mortgage loan data source 150. The mortgage loan data source 150 may be, for example, a database or file with a compiled set of loan data from disparate sources such as loan originators, financial institutions, etc. The interface module 110 receives mortgage loan data information from the mortgage loan data source 150 and outputs the information, values, data, etc. to the quality control module 140.

The parameter control module 120 stores and maintains information, business rules, data, etc. related to the requirements for submitting accurate and complete mortgage loan data. The information includes, for example, a list of predetermined quality control parameters utilized to identify missing and/or suspect information in a mortgage data record. An exemplary list of predetermined quality control parameters with corresponding descriptions are provided in Table 1.

TABLE 1

| QC Check Name | Quality Control Check Description |
|---|---|
| Missing property zip | Check for null values or blanks |
| code | |
| Invalid property zip | Check against a lookup table of all valid US zip codes |
| code | |
| Missing property state | Check for null values or blanks |
| Invalid property state | Check against a lookup table of all valid US state |
| | abbreviations |
| Property zip, state | Check against a lookup table of all valid US zip code & state |
| conflict | combinations |
| Missing property type | Check for null values or blanks |
| code | |
| Invalid property type | Check against a lookup table of valid property type codes as |
| code | defined by LoanPerformance |
| Missing units value | Check for null values, blanks or zero |
| Suspect units value | Check if the # of units is not between 1 and 4 |
| Property type code, | Check if property type is single-family and units is not 1, if |
| units conflict | property type is “2-4 unit” and units is not between 2 and 4, |
| | or if property type is multifamily and units is less than 5 |
| Missing occupancy code | Check for null values or blanks |
| Invalid occupancy code | Check against a lookup table of valid occupancy codes as |
| | defined by LoanPerformance |
| Missing origination date | Check for null values, blanks or zero |
| Invalid origination date | Check to see if date is not “valid”, not YYYYMMDD format |
| Origination date in the | Check if origination date is later than the processing date |
| future | |
| Invalid maturity date | Check to see if date is not “valid”, not YYYYMMDD format |
| Maturity date has | Check if maturity date is earlier than processing date |
| passed | |
| Invalid first payment | Check to see if date is not “valid”, not YYYYMMDD format |
| date | |
| Origination date, first | Check if origination date is not 1 to 2 months earlier than |
| payment date conflict | first payment date |
| Missing original balance | Check for nulls or zero |
| Suspect original balance | Check if first lien and original balance <$10,000, or if |
| | original balance >$10,000,000 |
| Missing balance at deal | Check for nulls or zero |
| close | |
| Suspect balance at deal | Check if first lien and balance as of deal close <$10,000, or |
| close | if balance as of deal close >$10,000,000 |
| Balance as of deal close | Check if balance as of deal close > original balance and loan |
| greater than original | is not eligible for negative amortization |
| balance | |
| Missing closing interest | Check for nulls or zero |
| rate | |
| Suspect closing interest | Check if closing interest rate is not between 1 and 25 |
| rate | |
| Missing appraised value | Check for nulls or zero |
| Suspect appraised value | Check if appraised value <$10,000 or >$10,000,000 |
| Missing sale price | Check for nulls or zero if loan purpose is “purchase” |
| Suspect sale price | Check if sale price <$10,000 or >$10,000,000 and loan |
| | purpose is “purchase”, or if sale price is not null and not |
| | zero and loan purpose is not “purchase” |
| Appraised value, sale | Check if appraised value >10 times sale price or original |
| price, or original | balance and first lien, or if sale price >10 times appraised |
| balance is suspect | value or original balance and first lien, or if original balance |
| | >10 times sale price or appraised value |
| Missing product type | Check for null values or blanks |
| code | |
| Invalid product type | Check against a lookup table of valid product type codes as |
| code | defined by LoanPerformance |
| Suspect original loan | Check if original loan term <24 or >480 |
| term | |
| Missing original loan | Check if term is missing and either of the following two is |
| term information | missing: maturity date first payment date |
| Loan term information | Check if term not = (maturity date − first payment date) + 1 |
| conflict | |
| Product type, loan term | Check if product type and original loan term conflict with |
| conflict | each other as defined by LoanPerformance |
| Missing original interest | Check for nulls or zero |
| rate | |
| Suspect original interest | Check if closing interest rate <1 or >25 |
| rate | |
| Closing interest rate, | Check if product type is “fixed rate” and closing interest rate |
| original interest rate | not = original interest rate |
| conflict | |
| Missing underwriting | Check for nulls or zero |
| ratio #1 | |
| Missing underwriting | Check for nulls or zero |
| ratio #2 | |
| Suspect underwriting | Checks if underwriting ratio(s) >99 |
| ratio(s) | |
| Missing loan type code | Check for null values or blanks |
| Invalid loan type code | Check against a lookup table of valid loan type codes as |
| | defined by LoanPerformance |
| Missing loan purpose | Check for null values or blanks |
| code | |
| Invalid purpose code | Check against a lookup table of valid purpose codes as |
| | defined by LoanPerformance |
| Purpose code, sale price | Check if purpose code is not “purchase” and sale price not |
| conflict | null or zero |
| Missing payment | Check for null values or blanks |
| frequency code | |
| Invalid payment | Check against a lookup table of valid payment frequency |
| frequency code | codes as defined by LoanPerformance |
| Missing loan source | Check for null values or blanks |
| code | |
| Invalid loan source code | Check against a lookup table of valid loan source codes as |
| | defined by LoanPerformance |
| Missing buydown code | Check for null values or blanks |
| Invalid buydown code | Check against a lookup table of valid buydown codes as |
| | defined by LoanPerformance |
| Missing documentation | Check for nulls or blanks |
| code | |
| Invalid documentation | Check against a lookup table of valid documentation codes |
| code | as defined by LoanPerformance |
| Missing PMI code | Check for nulls or blanks |
| Invalid PMI code | Check against a lookup table of valid PMI codes as defined |
| | by LoanPerformance |
| Missing convertibility | Check for nulls or blanks |
| flag | |
| Invalid convertibility | Check against a lookup table of valid convertibility flag codes |
| flag | as defined by LoanPerformance |
| Missing pool insurance | Check for nulls or blanks |
| code | |
| Invalid pool insurance | Check against a lookup table of valid pool insurance codes |
| code | as defined by LoanPerformance |
| Missing recourse code | Check for nulls or blanks |
| Invalid recourse code | Check against a lookup table of valid recourse codes as |
| | defined by LoanPerformance |
| Missing original LTV | Check for null values or zero |
| Suspect original LTV | Check if first lien and original LTV <10 or >110, if not first |
| | lien and original LTV <20 or >125 |
| Original LTV, original | Check if purpose is “purchase” and original LTV not = original |
| balance, appraised | balance/min(appraised value, sale price) ± 2%, if |
| value, sale price conflict | purpose is not “purchase” and original LTV not = original |
| | balance/appraised value ± 2% |
| Missing servicing fee | Check for null values or zero |
| Suspect servicing fee | Check if servicing fee < zero or >2.00 |
| Missing negam flag | Check for null values or zero, if product type is not fixed |
| Invalid negam flag | Check against a lookup table of valid negam flag codes as |
| | defined by LoanPerformance |
| Product type, negam | Check if product type is “fixed rate” and negam flag is YES |
| flag conflict | |
| Missing negam limit | Check for null values or zero, if product type is not “fixed |
| | rate” |
| Suspect negam limit | Check if negam limit <105% or >130% |
| Negam flag, negam | Check if negam flag is NO and negam limit is not null or zero |
| limit conflict | |
| Invalid index code | Check against a lookup table of valid index codes, if product |
| | type is not “fixed rate” |
| Product type, index | Check if product type is “fixed rate” and index code is not |
| code conflict | null or blanks, if product type is not “fixed rate” and index |
| | code is null or blanks |
| Suspect margin | Check if margin < zero or >15 |
| Product type, margin | Check if product type is “fixed rate” and margin is not null or |
| conflict | zero, if product type is not “fixed rate” and margin is null or |
| | zero |
| Suspect periodic rate | Check if periodic rate cap < zero or >8 |
| cap | |
| Product type, periodic | Check if product type is “fixed rate” and periodic rate cap is |
| rate cap conflict | not null or zero, if product type is not “fixed rate” and |
| | periodic rate cap is null or zero |
| Suspect periodic rate | Check if periodic rate floor < zero or >8 |
| floor | |
| Product type, periodic | Check if product type is “fixed rate” and periodic rate floor is |
| rate floor conflict | not null or zero |
| Suspect periodic pay | Check if periodic pay cap <1 or >15 and negam flag is YES |
| cap | |
| Suspect periodic pay | Check if periodic pay floor <1 or >15 and negam flag is |
| floor | YES |
| Product type, lifetime | Check if product type is “fixed rate” and lifetime rate cap is |
| rate cap conflict | not null or zero, if product type is not “fixed rate” and |
| | lifetime rate cap is null or zero |
| Lifetime rate cap, | Check if lifetime rate cap <= lifetime rate floor |
| lifetime rate floor | |
| conflict | |
| Suspect lifetime rate | Check if lifetime rate floor < zero or >25 |
| floor | |
| Suspect lifetime rate | Check if lifetime rate floor > interest rate at deal closing or |
| floor | >original interest rate |
| Product type, lifetime | Check if product type is “fixed rate” and lifetime rate floor is |
| rate floor conflict | not null or zero |
| Suspect rate reset | Check if rate reset frequency not = 1, 3 or 6 and not |
| frequency | divisible by 12 |
| Product type, rate reset | Check if product type is “fixed rate” and rate reset frequency |
| frequency conflict | is not null or zero, if product type is not “fixed rate” and rate |
| | reset frequency is null or zero |
| Suspect pay reset | Check if pay reset frequency not = 1, 3 or 6 and not |
| frequency | divisible by 12 |
| Product type, pay reset | Check if product type is “fixed rate” and pay reset frequency |
| frequency conflict | is not null or zero, if product type is not “fixed rate” and pay |
| | reset frequency is null or zero |
| Negam flag, ARM | Check if negam flag is YES and periodic pay cap is null or |
| characteristics conflict | zero and rate reset frequency = pay reset frequency, if |
| | negam flag is NO and periodic pay is not null and not zero or |
| | rate reset is more frequent than pay reset |
| Suspect first rate reset | Check if first rate reset not = 1, 3 or 6 and not divisible by |
| frequency | 12 |
| Suspect first pay reset | Check if first pay reset not = 1, 3 or 6 and not divisible by |
| frequency | 12 |
| Missing raw | Check for null values or blanks |
| documentation code | |
| Missing FICO score at | Check for null values or zero |
| origination | |
| Invalid FICO score at | Check if FICO score <300 or >899 |
| origination | |
| Missing lien position | Check for null values or blanks |
| Invalid lien position | Check against a lookup table of valid lien positions as |
| | defined by LoanPerformance |
| PMI code, lien conflict | Check if PMI code is not null or blank and not first lien |
| Missing raw paper grade | Check for null values or blanks |
| Missing paper grade | Check for null values or blanks |
| Missing prepay penalty | Check for null values or blanks |
| flag | |
| Invalid prepay penalty | Check against a lookup table of valid prepay penalty flag |
| flag | codes as defined by LoanPerformance |
| Missing prepay penalty | Check for null values or blanks, if prepay penalty flag is YES |
| term | |
| Suspect prepay penalty | Check if prepay penalty term < zero or >60 |
| term | |
| Prepay penalty flag, | Check if prepay penalty term is not null or zero and prepay |
| prepay penalty term | penalty flag is NO |
| conflict | |
| Suspect first rate cap | Check if first rate cap < zero or >8, or if first rate cap is |
| | non-zero and first rate cap <periodic rate cap |
| First rate reset, first | Check if first rate reset is null and first rate cap is not null or |
| rate cap conflict | zero, if first rate reset is not null and first rate cap is null or |
| | zero |
| Suspect PMI level | Check if PMI level coverage <4 or >40 |
| coverage | |
| PMI code, PMI level | Check if PMI code is null or blanks and PMI level coverage is |
| coverage conflict | not null or zero, if PMI code is not null and not blanks and |
| | PMI level coverage is null or zero |
| Missing pledge amount | Check for null values or zero, if loan type is “pledged” |
| Suspect pledge amount | Check if pledge amount > original balance |
| Suspect effective LTV | Check if loan type is “pledged” and effective LTV <10 or >85 |
| Loan type, pledge | Check if loan type is “pledged” and pledge amount or |
| amount, effective LTV | effective LTV are null or zero, if loan type is not “pledged” |
| conflict | and pledge amount or effective LTV are not null or zero |
| Loan type, LTV, | Check if loan type is “pledged” and LTV not = effective LTV |
| effective LTV conflict | |
| Lien, LTV, combined LTV | Check if not first lien and LTV and combined LTV are both |
| conflict | non-zero and LTV not = combined LTV, or if first lien and |
| | combined LTV < LTV |
| Suspect first LTV | Check if first LTV <10 or >110 |
| Suspect second LTV | Check if second LTV < zero or >50 |
| Suspect combined LTV | Check if combined LTV <20 or >125 |
| First LTV, second LTV, | Check if first LTV, second LTV, and combined LTV are all |
| combined LTV conflict | non-zero and combined LTV not = first LTV + second LTV |
| Missing last paid | Check for nulls or blanks or zero, if actual balance > zero |
| interest date | |
| Invalid last paid interest | Check to see if date is not “valid”, not YYYYMMDD format |
| date | |
| Last paid interest date | Check if the current month's last paid interest date is before |
| moved backwards | prior month's last paid interest date |
| Missing actual balance | Check for nulls or zero |
| Actual balance went up | Check if product type is “fixed rate” or product type is not |
| | “fixed rate” and negam = 0 and if current month's actual |
| | balance > prior month's actual balance |
| Actual balance, original | Check if actual balance > original balance and original |
| balance conflict | balance > zero |
| Actual balance, balance | Check if actual balance > balance at deal close and balance |
| at deal close conflict | at deal close > zero |
| Missing current interest | Check for nulls or zero |
| rate | |
| Suspect current interest | Check if current interest rate <1 or >25 |
| rate | |
| Closing interest rate, | Check if product type is “fixed rate” and closing interest rate |
| current interest rate | not = current interest rate |
| conflict | |
| Current interest rate | Check if product type is “fixed rate” and current month's |
| changes | current rate not = prior month's current rate |
| Current interest rate, | Check if product type is not “fixed rate” and current month's |
| periodic rate cap, | current interest rate − prior month's current interest rate > periodic |
| periodic rate floor | rate cap or prior month's current interest rate − current |
| conflict | month's current interest rate > periodic rate cap |
| Current interest rate, | Check if product type is not “fixed rate” and current month's |
| first rate cap conflict | current interest rate − prior month's current interest rate > first |
| | rate cap (first rate adjustment only) |
| Current interest rate, | Check if product type is not “fixed rate” and current interest |
| lifetime rate cap conflict | rate > lifetime rate cap |
| Current interest rate, | Check if product type is not “fixed rate” and current interest |
| lifetime rate floor | rate < lifetime rate floor |
| conflict | |
| Missing total payment | Check for nulls or zero |
| due | |
| Missing scheduled | Check for nulls or zero |
| principal | |
| Missing scheduled P&I | Check for nulls or zero |
| Suspect scheduled P&I | Check if scheduled P&I <$100 or >$100,000 |
| Suspect ARM scheduled | Check if product type is not “fixed rate” and (current |
| P&I change | month's scheduled P&I − prior month's scheduled P&I)/ |
| | prior month's scheduled P&I > periodic pay cap, or if (prior |
| | month's scheduled P&I − current month's scheduled P&I)/ |
| | prior month's scheduled P&I > periodic pay cap |
| Scheduled principal, | Check if both scheduled principal and scheduled P&I are not |
| scheduled P&I conflict | missing and scheduled P&I minus scheduled principal not = calculated |
| | interest due (balance times (rate divided by 12)) |
| Product type, scheduled | Check if product type is “interest only” and scheduled P&I |
| P&I conflict | not = scheduled interest due (balance times (rate divided by |
| | 12)), ±$1 (during IO term only) |
| | Check if product type is not “interest only” and scheduled |
| | P&I = scheduled interest due (balance times (rate divided by |
| | 12)), ±$1 |
| Negam flag, scheduled | Check if negam flag is NO and scheduled P&I < scheduled |
| P&I conflict | interest due (scheduled P&I minus scheduled principal) |
| Missing MBA | Check for nulls or blanks |
| delinquency status | |
| Invalid MBA delinquency | Check against a lookup table of valid MBA delinquency |
| status | statuses as defined by LoanPerformance |
| Missing OTS | Check for nulls or blanks |
| delinquency status | |
| Invalid OTS delinquency | Check against a lookup table of valid OTS delinquency |
| status | statuses as defined by LoanPerformance |
| Actual balance, MBA | Check if actual balance = 0 and MBA delinquency status or |
| delinquency status, OTS | OTS delinquency status is not “paid off” (or vice versa) |
| delinquency status | |
| conflict | |
| MBA delinquency status, | Check if 12th character of delinquency history string not = MBA |
| delinquency history | delinquency status |
| conflict | |
| Suspect delinquency | Check if a status of “current” is followed by a status of “60 |
| history #1 | days” or “90 days” or “foreclosure” or “REO” |
| Suspect delinquency | Check if a status of “30 days” is followed by a status of “90 |
| history #2 | days” or “foreclosure” or “REO” |
| Suspect delinquency | Check if status of “foreclosure” is followed by anything other |
| history #3 | than a status of another “foreclosure” or “REO” or “missing” |
| | or “paid off” |
| Suspect delinquency | Check if a status of “REO” is followed by anything other than |
| history #4 | a status of another “REO” or “missing” or “paid off” |
| Suspect delinquency | Check if a status of “paid off” is followed by anything other |
| history #5 | than a status of another “paid off” or “missing” |
| Exception flag, MBA | Check if exception flag is “foreclosure” and MBA delinquency |
| delinquency status, OTS | status or OTS delinquency status is not “foreclosure” (or vice |
| delinquency status | versa) |
| conflict #1 | |
| Exception flag, MBA | Check if exception flag is “REO” and MBA delinquency status |
| delinquency status, OTS | or OTS delinquency status is not “REO” (or vice versa) |
| delinquency status | |
| conflict #2 | |
| Exception flag, MBA | Check if exception flag is “paid off” and MBA delinquency |
| delinquency status, OTS | status or OTS delinquency status is not “paid off” (or vice |
| delinquency status | versa) |
| conflict #3 | |
| Invalid foreclosure start | Check to see if date is not “valid”, not YYYYMMDD format |
| date | |
| Foreclosure start date, | Check if exception flag is “foreclosure” and foreclosure start |
| exception flag conflict | date is not populated (or vice versa) |
| Invalid foreclosure end | Check to see if date is not “valid”, not YYYYMMDD format |
| date | |
| Foreclosure end date, | Check if previous month's exception flag is “foreclosure” and |
| exception flag conflict | current month's exception flag is not “foreclosure” and |
| | foreclosure end date is not populated (or vice versa) |
| Foreclosure start date, | Check if foreclosure end date is before foreclosure start date |
| foreclosure end date | |
| conflict | |
| Invalid payoff date | Check to see if date is not “valid”, not YYYYMMDD format |
| Payoff date, actual | Check if payoff date is filled in and actual balance is not zero |
| balance conflict | (or vice versa) |
| Invalid REO date | Check to see if date is not “valid”, not YYYYMMDD format |
| REO date, exception | Check if previous month's exception flag is not “REO” and |
| flag conflict | current month's exception flag is “REO” and REO date is not |
| | populated |
| Missing investor balance | Check for nulls or zero |
| Investor balance went | Check if product type is “fixed rate” or product type is not |
| up | “fixed rate” and negam flag is NO and current month's |
| | investor balance > prior month's investor balance |
| Investor balance, | Check if investor balance > original balance |
| original balance conflict | |
| Investor balance, | Check if investor balance > balance at deal close |
| balance at deal close | |
| conflict | |
| Product type, interest | Check if interest rate at next reset is populated and product |
| rate at next reset | type is “fixed rate” |
| conflict | |
| Suspect loss severity | Check if first lien and loss severity (i.e., loss amount/original |
| | balance) >125%, if not first lien and loss severity (i.e., loss |
| | amount/original balance) >150% |
| Missing net pass- | Check for nulls or zero |
| through rate | |
| Suspect net pass- | Check if net pass-through rate <1 or >25 |
| through rate | |
| Net pass-through rate | For fixed loans, if current month's net pass-through rate not = prior |
| changes | month's net pass-through rate |
| Current interest rate, | Check if product type is “fixed rate” and current rate ≦ net |
| net pass-through rate | pass-through rate or (current rate − net pass-through rate) > 3.0 |
| conflict | |

PMI—Private Mortgage Insurance. Mortgages that have an LTV over 80% are usually required to carry PMI, which would cover losses incurred by the lender/owner of the mortgage in case of default.
LTV—Loan to Value, calculated as the ratio between the loan balance and either the appraised value of the property or then sale price (whichever is lower).
Negam—Negative amortization. Under certain circumstances, the $ balance of a loan can actually increase over time.
FICO—A commonly used credit score used to measure the creditworthiness of a borrower or potential borrower.
P&I—Principal & Interest payment. The monthly payment due on the loan, not including any escrow, taxes, insurance, fees or additional items.
OTS—Office of Thrift Supervision. This method of determining delinquency status of the loan uses the due date anniversary as the cut-off. For example, if the due data is January 1, then the loan is considered delinquent if payment is not received by February 1 (the anniversary of the January 1 due date).
MBA—Mortgage Bankers Association. This method of determining delinquency status of the loan uses the day before the due date anniversary as the cut-off. For example, if the due data is January 1, then the loan is considered delinquent if payment is not received by January 31 (the day before February 1, the anniversary of the January 1 due date).
REO—Real Estate Owned.

The parameter control module 120, in an exemplary embodiment, may further include guidelines or rules related to: missing property zip codes, invalid property zip codes, missing property state information, invalid property state information, conflicting property state/zip code information, missing property type code, invalid property type code, missing units value, suspect units value, conflicting property type code/units value, missing occupancy code, invalid occupancy code, missing origination date, invalid origination date, a future origination date, invalid maturity date, a passed maturity date, invalid first payment date, conflicting origination date/first payment dates, missing original balance, suspect original balance, etc. Other guidelines, rules, etc. may be utilized or defined to verify data, information, values, etc., commonly found in mortgage loans.

The command module 130 stores or maintains instructions, algorithms, processes, etc., for managing the missing and/or suspect information. The command module 130 may include an instruction to, for example, create a report for missing information, and/or correct, remove and/or report suspect information. The command module 130 may also include instructions for standardizing and/or organizing the received mortgage loan data.

The quality control module 140 communicates with the interface module 110, the parameter control module 120 and the command module 130. The quality control module 140 manages the mortgage loan data information received from the loan data source 150 via the interface module. The loan data source 150 may provide the mortgage loan data in batches of files that include any number of mortgage loan data information. For example, a single batch provided by the loan date source 150 may include thousands or even millions of records relating to mortgage loans. The batch information may be provided in a text, ASCII XML, CSV or any other transferable file format. The batch information may be, for example, delivered electronically via the wired or wireless network interface 190 in communication with an FTP site, an email attachment, or physically via a DVD, CD, USB drive, solid state storage or magnetic tape. The management module 130 identifies missing and/or suspect information in the mortgage loan data utilizing the guidelines and parameters stored or provided by the parameter control module 120. The quality control module 140 may further perform data standardization and organization, corrective and/or reporting tasks provided by the command module 130. The quality control module 140 may, in turn, output verified data 160 usable by the user of the system 100.

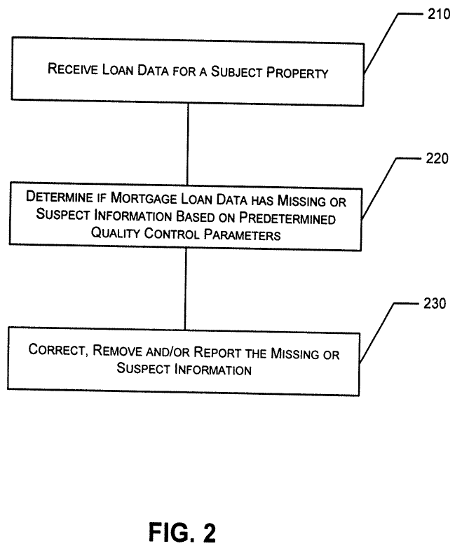

FIG. 2 illustrates an exemplary flow chart representing the QC steps or functions implemented by the system 100. At block 210, the system 100 receives mortgage loan data relating to a subject property from the mortgage loan data source 150. For example, the mortgage loan data source 150 may provide a batch file containing multiple individual data files that represent approved and active mortgages and loans relating to properties.

At block 220, the system 100 determines if the received mortgage loan data contains missing or anomalous information based on the predetermined quality control parameters stored within the parameter control module 120. For example, the predetermined quality control parameters, such as the parameters listed in Table 1, may be organized into numerous rules, business functions or logic constructs and sequentially executed or evaluated to check or verify the quality or status of the received mortgage loan data.

At block 230, if the system 100 identifies missing or anomalous information, the identified information may be corrected, removed or correlated and reported to the user. For example, one or more of the one-hundred and eighty (180) parameters may be compared or evaluated to the values within each of the individual data files that comprise the batch. Deviations or discrepancies from an expected result may be logged, noted and/or corrected. By implementing numerous check or validation cycles utilizing multiple, for example twenty or more, quality control parameters, the mortgage loan data contained within the batch file may be transformed or converted into verified and trustworthy information better usable for financial related transactions. The identification, correction and/or removal of anomalies in the individual data files allow clients and users to compile accurate files and databases for active loans and mortgage products. These accurate files and databases may, in turn, be utilized by mortgage resellers, financial institutions, etc., to determine business plans and strategies, trades, sells, buying, or other financial transaction with a degree of confidence and based on accurate “raw” data, i.e., the quality corrected mortgage loan data stored within the files and databases.

The quality corrected mortgage loan data stored within the files and databases provide accurate prepayment and default risk assessment which may be helpful in competing successfully in the mortgage servicing business. The system 100 provides the quality corrected mortgage loan data to loan servicing entities, and other financial institutions to allow for accurate risk assessments based on the files and databases. These files and databases may relate to prime databases, subprime databases and/or HELOC/second databases.

The system 100 may be implemented and integrated into the standard processes of the user to provide proactive data integrity checks and verification. The system 100 may execute, for example, continuously, once a month, etc. to reduce the time and cost associated with providing verified data 160 to the user.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A computer implemented quality control system configured for verification of mortgage loan data, the system comprising:
a network interface device;
a processor in communication with the network interface device via a communication bus;
a memory in communication with the processor and the network interface device via the communication bus, the memory configured to store computer readable instructions programmed to include:
an interface module configured to receive mortgage loan data, wherein the mortgage loan data represents a plurality of existing individual mortgages from one or more mortgage sources;
a parameter control module configured to store twenty or more predetermined quality control parameters, wherein the quality control parameters represent potential inconsistencies, inaccuracies, missing information, or combinations thereof in the mortgage loan data;
a command module configured to store processing instructions utilized to comprehensively analyze the received the mortgage loan data; and
a quality control module in communication with the interface module, the parameter control module and the command module, wherein the quality control module is configured to utilize the quality control parameters and the processing instructions to identify anomalies in the received mortgage loan data.

2. The system of claim 1 further comprising:
a mortgage loan data source in communication with the interface module.

3. The system of claim 2, wherein the mortgage loan data source is a mortgage loan servicing entity.

4. The system of claim 1, wherein the quality control module is configured to automatically identify anomalies in the received mortgage loan data.

5. The system of claim 1, wherein the quality control module is configured to generate a report based on the identified anomalies.

6. The system of claim 1, wherein the quality control module is configured to correct the identified anomalies.

7. The system of claim 1, wherein the quality control parameters include at least one hundred quality control parameters.

8. The system of claim 13, wherein the quality control parameters include between one hundred and two hundred quality control parameters.

9. A method for providing quality control verification of mortgage loan data, the method comprising:
receiving a plurality of mortgage loan data, wherein each of the plurality of mortgage loan data includes a plurality of data fields and each of the data fields relate to a subject property;
analyzing the received plurality of mortgage loan data, wherein analyzing further comprises:
identifying anomalies in the received plurality of mortgage loan data as a function of one or more quality control parameters; and
correcting the anomalies identified within the analyzed mortgage loan data.

10. The method of claim 9, wherein analyzing the received plurality of mortgage loan data is an automatic process.

11. The method of claim 9, wherein analyzing the received plurality of mortgage loan data further comprises:
organizing the received plurality of mortgage loan data into a standardized format.

12. The method of claim 9, wherein identifying anomalies further includes identifying errors in the received plurality of mortgage loan data.

13. The method of claim 9 further comprising:
generating a report based on the identified anomalies.

14. The method of claim 9, wherein the one or more quality control parameters include at least one hundred quality control parameters.

15. The method of claim 9, wherein the one or more quality control parameters include between one hundred and two hundred quality control parameters.

16. A method for providing quality control verification of mortgage loan data, the method comprising:
receiving a plurality of mortgage loan data, wherein each of the plurality of mortgage loan data includes a plurality of data fields and each of the data fields relates to a subject property;
analyzing the received plurality of mortgage loan data, wherein analyzing further comprises:
identifying anomalies in the received data fields of the plurality of mortgage loan data as a function of one or more quality control parameters;
identifying anomalies in the received data fields of the plurality of mortgage loan data as a function of a second group of received data fields of the plurality of mortgage loan data; and
generating a report based on the identified anomalies.

17. The method of claim 16, wherein analyzing the received plurality of mortgage loan data is an automatic process.

18. The method of claim 16, wherein analyzing the received plurality of mortgage loan data further comprises:
organizing the received plurality of mortgage loan data into a standardized format.

19. The method of claim 16, wherein identifying anomalies further includes identifying errors in the received plurality of mortgage loan data.

20. The method of claim 16 further comprising:
correcting the anomalies identified within the analyzed mortgage loan data.
